(19) United States
(12) Patent Application Publication
(10) Pub. No.: US 2020/0309232 A1
(43) Pub. Date: Oct. 1, 2020

(54) Torque-Transmission Device

(71) Applicant: ZF FRIEDRICHSHAFEN AG, Friedrichshafen (DE)

(72) Inventors: Tobias HÖCHE, Hofheim i. UFr. (DE); Tobias DIECKHOFF, Würzburg (DE); Daniel LORENZ, Bad Kissingen (DE); Andreas ORLAMÜNDER, Schonungen (DE); Ingrid HOFFELNER, Knetzgau (DE); Wolfgang GROSSPIETSCH, Schweinfurt (DE); Steffen MATSCHAS, Bad Bocklet-Aschach (DE); Johannes FRIESS, Michelau im Steigerwald (DE); Christofer EBERT, Schweinfurt (DE); Matthias KRAM, Würzburg (DE); Dennis EGLER, Espenau (DE); Axel ROHM, Schonungen (DE); Erwin WACK, Niederwerrn (DE); Bernd UNSELD, Ravensburg (DE); Thomas DOGEL, Nüdlingen (DE); Matthias REISCH, Ravensburg (DE)

(21) Appl. No.: 16/313,443

(22) PCT Filed: May 29, 2017
(86) PCT No.: PCT/EP2017/062835

§ 371 Date: Dec. 26, 2018

(30) Foreign Application Priority Data
Jun. 30, 2016 (DE) 10 2016 211 954.0

(51) Int. Cl. F16F 15/131; F16H 45/02; F16F 15/14; F16F 15/123

(52) U.S. Cl. CPC F16F 15/13121; F16H 45/02; F16H 2045/0221; F16F 15/12353; F16F 15/1407

(57) ABSTRACT

A torque transmission arrangement for a powertrain of a motor vehicle includes an input and an output. A torque path runs from the input to the output. A torsional vibration damping unit is positioned first, followed by a gear unit, along the torque path between the input and the output. A first slip arrangement and/or a second slip arrangement for generating a speed slip are/is provided in the torque path between the input and the output for vibration damping.

### CROSS REFERENCE TO RELATED APPLICATIONS

This is a U.S. national stage of application No. PCT/EP2017/062835, filed on May 29, 2017. Priority is claimed on German Application No. DE102016211954.0, filed Jun. 30, 2016, the content of which is incorporated here by reference.

### BACKGROUND OF THE INVENTION

### 1. Field of the Invention

The present invention is directed to a torque transmission device for a powertrain of a motor vehicle with an input area formed principally by an internal combustion engine, a downstream torsional vibration damping unit, a transmission arrangement and a downstream output area which is formed principally by a transmission output shaft.

### 2. Description of the Prior Art

A torque transmission device in which a torsional vibration damping arrangement with a mass damper unit in a housing area is provided between a drive unit and a gear unit is known from DE 10 2014 206 330 A1.

US 2011259698 shows a torque transmission device with a torsional vibration damping arrangement comprising a torsional damper and a mass damper unit in a housing area upstream of a gear unit.

However, it is disadvantageous in the known torque transmission devices that the individual components responsible for reducing torsional vibrations on the one hand and for transmitting torque on the other hand are not provided or arranged in the torque transmission device in an advantageous, space-saving, or economical manner in accordance with their operation.

Therefore, it is an object of one aspect of the present invention to provide a torque transmission device in which torsional vibrations are reduced and torque is transmitted in an efficient, space-saving and economical manner.

According to one aspect of the invention, a torque transmission arrangement for a powertrain of a motor vehicle comprises an input area rotatable around a rotational axis (A) and an output area rotatable around a rotational axis (B), a torque path (M) runs from the input area to the output area, a torsional vibration damping unit is positioned first, followed by a gear unit (33), along the torque path (M) between the input area and the output area, and a first slip arrangement and/or a second slip arrangement for generating a speed slip are/is provided in the torque path (M) between the input area and the output area for vibration damping.

In a further advantageous embodiment form, it is provided that the first slip arrangement and/or the second slip arrangement provide(s) a speed slip, which is fixed or adjustable at an operating point of the torque transmission arrangement.

The torsional vibration damping unit can also comprise along the torque path (M) at least a first spatial area formed as a dry space or as a moist space.

Further, it may be advantageous when the torsional vibration damping unit comprises along the torque path (M) a second spatial area formed as a dry space or as a moist space.

The gear unit can also comprise a third spatial area, this third spatial area being formed as a wet space.

In a further advantageous embodiment form, a first spring set and/or a mass damper unit and/or a second spring set and/or the first slip arrangement and/or an electric drive unit and/or a first starting element are/is provided in the torsional vibration damping unit in torque path (M). All of these component parts can advantageously be operated in an oil mist-containing space.

Further, a converter unit or a dual clutch is provided in the torsional vibration damping unit in torque path (M) in the first spatial area and/or in the second spatial area.

A second starting element and/or the second slip arrangement may also be provided in the third spatial area and in the torque path (M).

Further, it may be advantageous when the converter unit comprises a torque converter with a converter lockup clutch.

In a further advantageous configuration, the mass damper unit may be constructed in particular as a speed-variable mass damper unit or as a fixed-frequency mass damper unit or as a mass damper unit for two or more engine orders.

The gear unit can also comprise a transmission arrangement constructed in particular as an automatic planet gear transmission or a manual or automatic shift transmission or a dual clutch transmission or a shiftless transmission.

Further advantages may result when the slip arrangement is constructed as a dry single disk clutch or a dry multiple disk clutch or a wet multiple plate clutch or a planetary transmission with a brake or a magnetorheological clutch or an electrorheological clutch or a magnetic clutch or a magnetic particle clutch. The wet-type embodiment forms are particularly advantageous because a thermal energy arising in the slip arrangement can be dissipated to a medium, which reduces thermal loading of the slip arrangement and, consequently, the slip arrangement can be operated more reliably and reproducibly.

It can also be advantageous that the first slip arrangement and/or the second slip arrangement form(s) a starting clutch. This is particularly advantageous for an installation space because no additional starting clutch need be installed.

It can also be advantageous when the first spatial area is separated from the second spatial area by a separate separating element.

The separating element can be provided with a radially outwardly circumferentially extending seal.

Further, the gear unit can comprise a third spatial area, which third spatial area is formed as a wet space, and the first spatial area is separated from the third spatial area by a separating element constructed as a separate separating element or is formed integrally with a housing element of the torsional vibration damping unit or is formed integrally with a housing element of the gear unit.

Also, the second spatial area can be separated from the third spatial area by a separating element formed as a separate separating element or formed integrally with a housing element of the torsional vibration damping unit or formed integrally with a housing element of the gear unit.

In a further advantageous embodiment form, the housing element of the torsional vibration damping unit and the housing element of the gear unit are formed integrally.

The first spring set and/or the second spring set can also be formed in one or more rows.

Further, rotational axis (A) can extend coaxial to rotational axis (B), or rotational axis (A) can extend axially offset to rotational axis (B).

Further, it may be advantageous when a first torque transmission path and, parallel thereto, a second torque transmission path and a coupling arrangement for superposing the torques conducted via the torque transmission paths are provided between the input area and the output area, and a first phase shifter arrangement is provided in the first torque transmission path for generating a phase shift of rotational irregularities conducted via the first torque transmission path relative to rotational irregularities conducted via the second torque transmission path, and the slip arrangement is provided after the coupling arrangement in the torque path (M).

### BRIEF DESCRIPTION OF THE DRAWINGS

The invention will be described more fully in the following referring to diagrams. The embodiment examples shown in the drawings only depict preferred constructions and shall not limit the scope of the invention which is defined solely by the appended claims.

The drawings show:

FIG. 1 is a schematic view of a torque transmission arrangement according to the invention; and

FIGS. 2 to 33 are further constructional variants of the torque transmission arrangement according to the invention.

### DETAILED DESCRIPTION OF THE PRESENTLY PREFERRED EMBODIMENTS

Like or identically functioning component parts are designated by like reference numerals in the following.

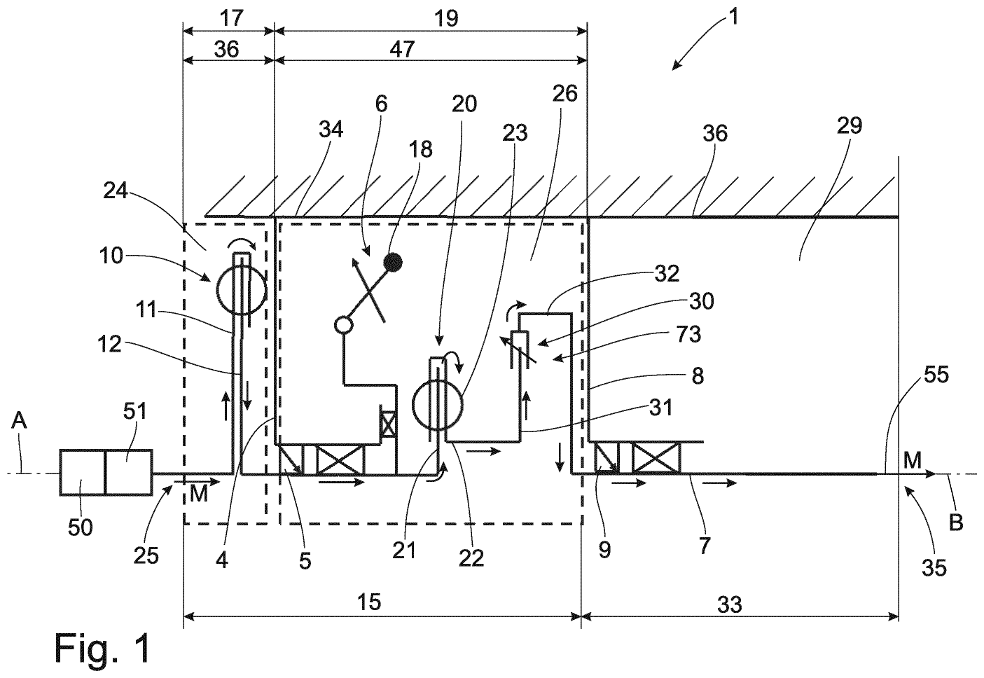

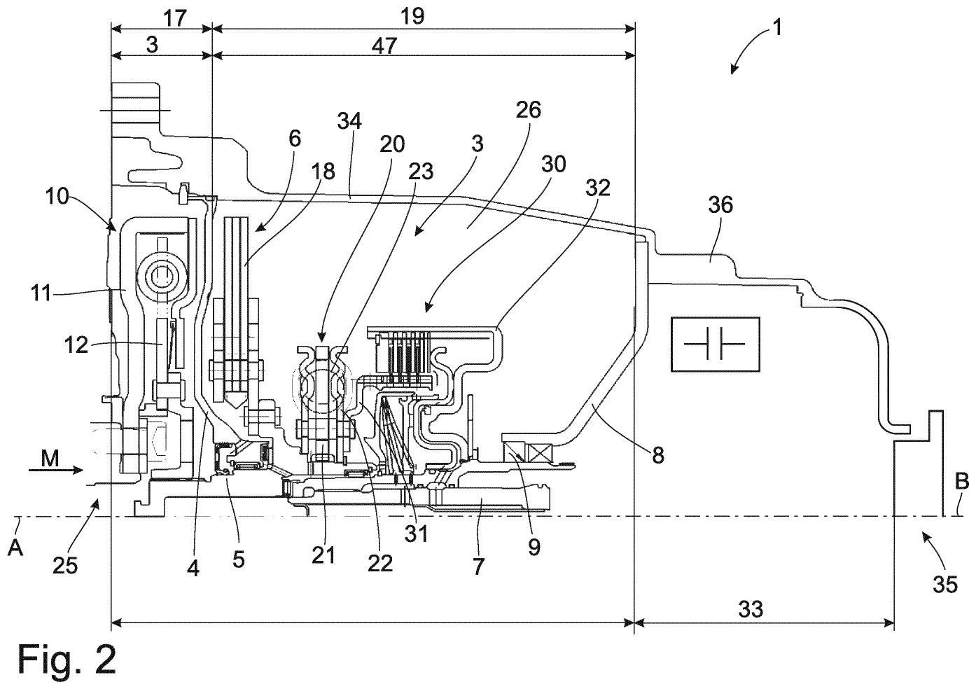

Both FIG. 1 and FIG. 2 show a torque transmission arrangement 1 in which an input part 11 of a first spring set 10 is fastened to a crankshaft 51 of a drive unit 50, for example, an internal combustion engine, so as to be fixed with respect to rotation relative to it. In the case depicted here, this spring set is a dual mass flywheel with spring plate/sliding shoes. Alternatively, this can also be formed with arc springs or can be constructed as a converter spring set. This dual mass flywheel can be filled with a lubricant (oil or grease) and is located in a first spatial area 17 which is separated in an oil-tight manner from a second spatial area 19 by a separating wall 4 together with accompanying seal 5. The first spatial area 17 is dry, i.e., free of lubricant, whereas there is a lubricant in the second spatial area 19. Oil in the form of an oil mist, a droplet lubrication or an oil bath is preferably provided for this purpose. Alternatively, it is also possible to use a lubricating grease or a semifluid grease. The ratio of an axial installation space height 3 of the first spatial area 17 to an axial installation space height 3 of the second spatial area 19 is between 1:3 and 1:5. A mass damper unit 6 is connected to an output part 12 of the first spring set 10, but is already located in the second spatial area 19. This output part 12 can also be arranged in an axial plane radially inside of the first spring set 10 in the first spatial area 17 in order to save axial installation space. The mass damper unit 6 is a speed-variable mass damper but can also be formed as a fixed-frequency mass damper. It can also be configured as a speed-variable mass damper to two engine orders. Taking into account the tolerance situation, the ratio between an outer diameter of the damper masses 18 and a diameter of a housing element 34 can be designed to a technically meaningful interval of 0.9 to 0.98, where the interval limits refer to a maximum installation space on the order of Ø300±20 mm, which is determined by the geometry of the housing 34. The input part 21 of the second spring set 20 is connected to the output part 12 of the first spring set 10 so as to be fixed with respect to rotation relative to it. The installed helical compression springs 23 of the second spring set 20 can be straight or curved. The output part 22 of the second spring set 20 is connected to an input part 31 of a slip arrangement 30 so as to be fixed with respect to rotation relative to it. An output part 32 is in turn connected to a transmission input shaft 7 so as to be fixed with respect to rotation relative to it. The slip arrangement 30 which can be constructed, for example, as a clutch and may comprise one or more friction surfaces. In order to achieve the lowest possible mass moment of inertia of the rotatable mass in its entirety, the second spring set 20 and the slip arrangement 30 are constructed to be radially compact such that their outer diameters are smaller than those of the first spring set 10 and of the mass damper unit 6. A stiffness ratio between first spring set 10 and second spring set 20 is between 1:7 and 1:10, where the ratio between the outer diameter of first spring set 10 and of second spring set 20 is approximately 1±0.3.

Depending on type of construction and function, an oil-tight separating element 8 with a seal 9 is provided between the second spatial area 19 and the gear unit 33, or a variant which provides that the second spatial area 19 merges into the gear unit 33 may also be possible.

A conventional stepped automatic transmission, a manual transmission, an automatic transmission, a dual clutch transmission, or a shiftless transmission can be provided in the gear unit 33. Further, it can also contain electric drive components (mild hybrid, full hybrid, or plug-in hybrid). Moreover, additional or standalone electric drive components, for example, a belt-driven starter generator, can also be realized upstream or downstream of the gear unit 33, between the drive unit 50 and the torsional vibration damping unit 15, upstream of the drive unit 50 or in the torsional vibration damping unit 15.

The first spring set 10 arranged upstream in the dry first space 17 and constructed as a dual mass flywheel together with the mass damper unit 6 interposed between first spring set 10 and second spring set 20 results in an appreciably better decoupling than with conventional damper systems in which the mass damper unit 6 is arranged downstream of both spring sets 10, 20.

However, since a connection of this type brings about rotational irregularity resonances in driving operation, it is advantageous to allow the downstream slip arrangement 30 to slip in driving operation in order to combat these resonances.

The grease-lubricated spring set 10, constructed as dual mass flywheel in the first dry spatial area 24, has advantages over a spring set in the moist space 26 with regard to stiffness, spring angle and vibration behavior.

In contrast to a mass damper unit in the dry space 17, the damper masses 18 of mass damper unit 6 in the second spatial area 19 can be selected bigger. Further, a wet slip arrangement 30 can be controlled better than a dry slip arrangement and, moreover, can better dissipate the heat generated during the slip process.

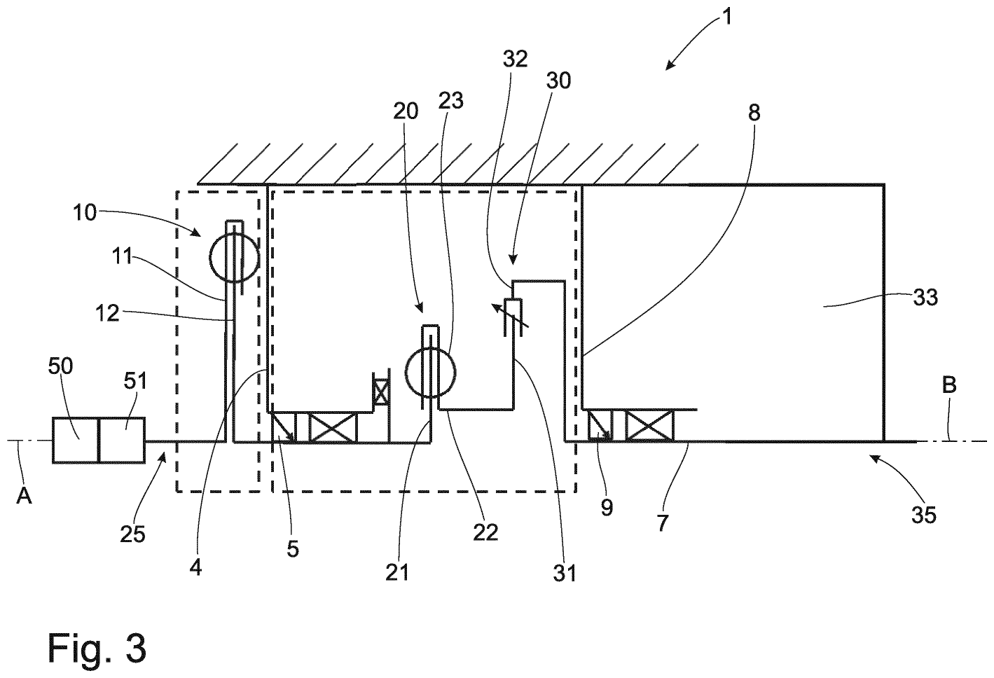

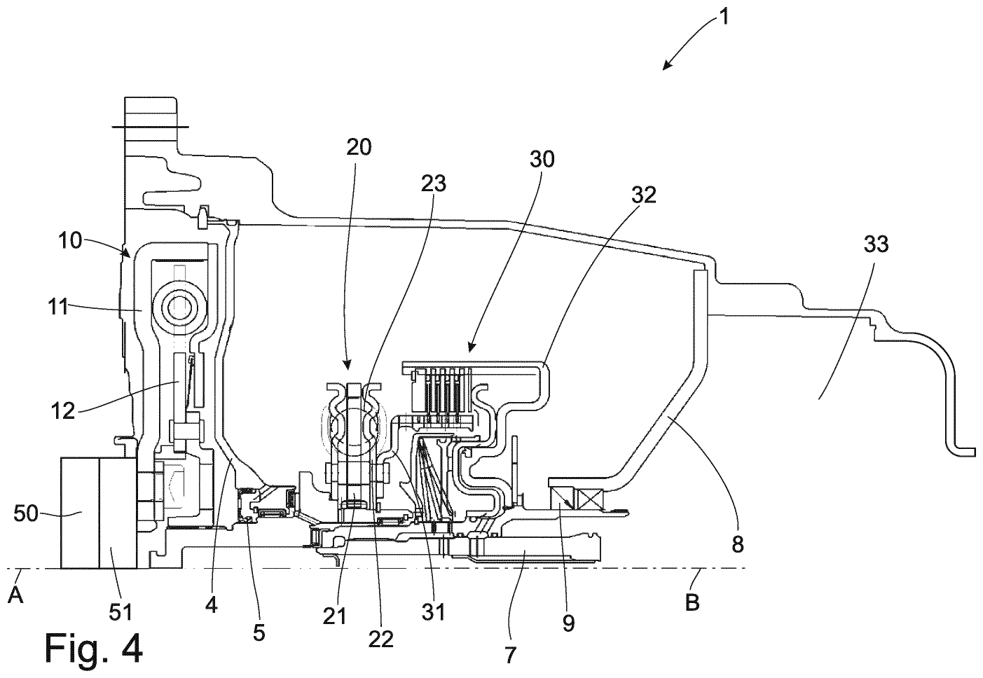

FIGS. 3 and 4 show a constructional variant as already described in FIGS. 1 and 2, but without the mass damper unit 6. However, in order to reduce axial installation space and mass moment of inertia, the mass damper unit 6 can be omitted. The positive effects of the slip arrangement 30 afford freedom in the layout of the two remaining spring sets 10, 20. Accordingly, a better decoupling can be achieved through slip arrangement 6 than with two conventional spring sets 10, 20 connected in tandem with rigid through-drive.

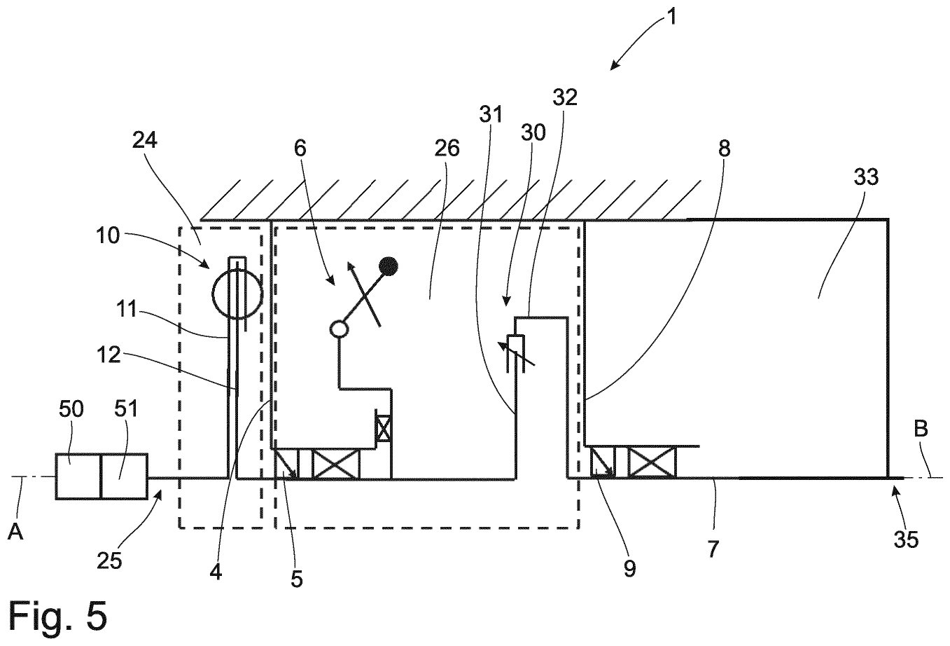

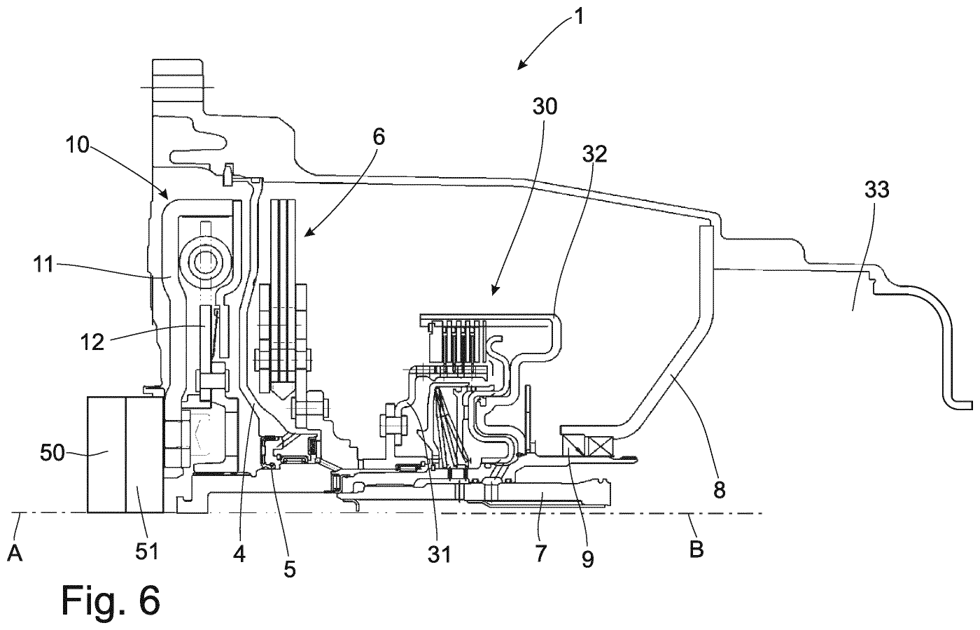

FIGS. 5 and 6 show an advantageous axially compact constructional variant as already described in FIGS. 1 and 2, but without the second spring set 20. As has also been described referring to FIGS. 1 and 2, the first spring set 10 is advantageously arranged in the dry space 24. The mass damper unit 6 and the slip arrangement 30 are advantageously arranged in the moist space 26, since these component parts are advantageously operated in an oil mist-containing space or in a space that is slightly filled with oil in order to minimize wear and friction in these component parts. It may also be advantageous to carry off heat energy from the slip arrangement 30 and, therefore, to achieve a stable heat balance. But the second spring set 20 can be omitted in order to reduce axial installation space and mass moment of inertia. The positive effects of the slip clutch afford freedom in the layout of the remaining spring set 10 and the mass damper unit 6. Accordingly, a better decoupling can be achieved compared with a conventional spring set 10 with downstream mass damper unit 6 with rigid through-drive.

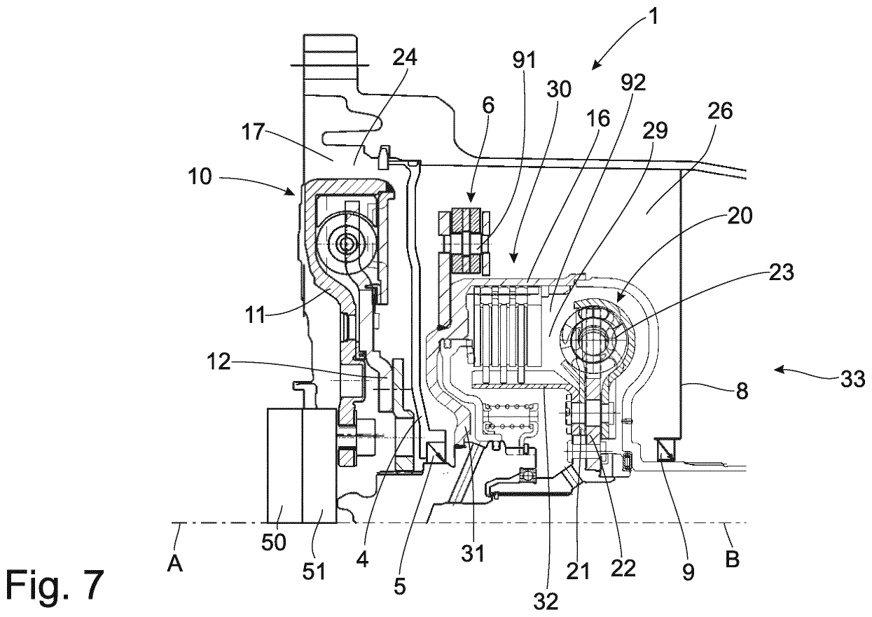

FIG. 7 shows a torque transmission arrangement 1 in which an input part 11 of a first spring set 10 is fastened to a crankshaft 51 of a drive unit 50, for example, an internal combustion engine, so as to be fixed with respect to rotation relative to it. In the case depicted here, this spring set is designed as a dual mass flywheel with spring plate/sliding shoes. Alternatively, this can also be formed with arc springs or can be constructed as a converter spring set. This dual mass flywheel can be filled with a lubricant (oil or grease) and is located in a first spatial area 17, which is separated in an oil-tight manner from a second spatial area 19 by a separating wall 4 together with accompanying seal 5. The first spatial area 17 is dry, i.e., free of lubricant, whereas there is a lubricant in the second spatial area 19. Oil in the form of an oil mist, a droplet lubrication or an oil bath is preferably provided for this purpose. Alternatively, it is also possible to use a lubricating grease or a semifluid grease. The droplet lubrication could be realized, for example, through a valve, not shown here, which directly faces a damper bolt 91 and which is correspondingly placed in a housing element 16 of the slip arrangement 30, in the present instance as an oil-cooled multiple plate clutch, also known as a hydrodynamic cooled clutch or HCC. Alternatively, it is also possible to use a lubricating grease or a semifluid grease. Depending on requirements, the separating wall 4 can also be dispensed with and, accordingly, there will be a larger dry area present.

The mass damper unit 6 which is located in this instance next to the first spring set 10 in the second spatial area 19 axially on the transmission side is connected to the output part 12 of the first spring set 10 so as to be fixed with respect to rotation relative to it. In order to economize on axial installation space, the mass damper unit 6 can also be arranged in an axial plane radially inside of the first spring set 10 in the dry first spatial area 24. The mass damper unit 6 is speed-variable but can also be formed as a fixed-frequency mass damper. It can also be configured as a speed-variable mass damper to two engine orders. The input part 31 of the slip arrangement 30 is connected to the output part 12 of the first spring set 10 so as to be fixed with respect to rotation relative to it. A slip arrangement space 92 is separated in an oil-tight manner from the first spatial area 17 or in an oil-tight manner from the second spatial area 19 through the co-rotating housing element 16. There is lubricant in the second spatial area 19. Oil in the form of an oil mist, a droplet lubrication or an oil bath is preferably provided for this purpose. Alternatively, it is also possible to use a lubricating grease or a semifluid grease. The output part 32 of the slip arrangement 30 is connected to the input part 21 of the second spring set 20 in the slip arrangement space 92 so as to be fixed with respect to rotation relative to it. The output part 22 of the second spring set 20 is in turn connected to the transmission input shaft 7 so as to be fixed with respect to rotation relative to it. The installed helical compression springs 23 can be straight or curved.

Alternatively, the second spring set 20 can also be dispensed with, or the first spring set 10 can be followed by one or more further spring sets, which can be located between first spring set 10 and mass damper unit 6, between mass damper unit 6 and slip arrangement 30 in the dry space 24 or in the moist space 19 or in the slip arrangement space 92.

The slip arrangement 30 can comprise one or more friction surfaces. In order to achieve the smallest possible mass moment of inertia, the slip arrangement 30 is constructed in this instance to be radially compact such that its outer diameter is appreciably smaller than that of the first spring set 10 and mass damper unit 6. Depending on type of construction and function, an oil-tight separating element 8 with a seal 9 can be provided between the second spatial area 19 and the gear unit 33, or a variant which provides that the second spatial area 19 merges into the gear unit 33 may also be possible.

A conventional stepped automatic transmission, a manual transmission, an automatic transmission, a dual clutch transmission or a shiftless transmission can be provided in the gear unit 33. Further, it can also contain electric drive components (mild hybrid, full hybrid or plug-in hybrid). Moreover, additional or standalone electric drive components, for example, a belt-driven starter generator, can also be realized upstream or downstream of the gear unit 33, between the drive unit 50 and the torsional vibration damping unit 15, upstream of the drive unit 50 or in the torsional vibration damping unit 15. The depicted combination of spring set 10, which is constructed as a dual mass flywheel, with external mass damper unit 6, both in the dry space 24, or the DMF in the dry space 24 and the mass damper unit in the moist space 26, with a wet slip arrangement 30 in the closed housing 16 rotating along with the latter offers a very good decoupling of rotational irregularities in a compact and lightweight construction. Owing to the small mass moment of inertia resulting from this, this solution lends itself above all to sporty vehicles having a high acceleration capacity. The modular construction makes it possible to use some components for other powertrain variants as well.

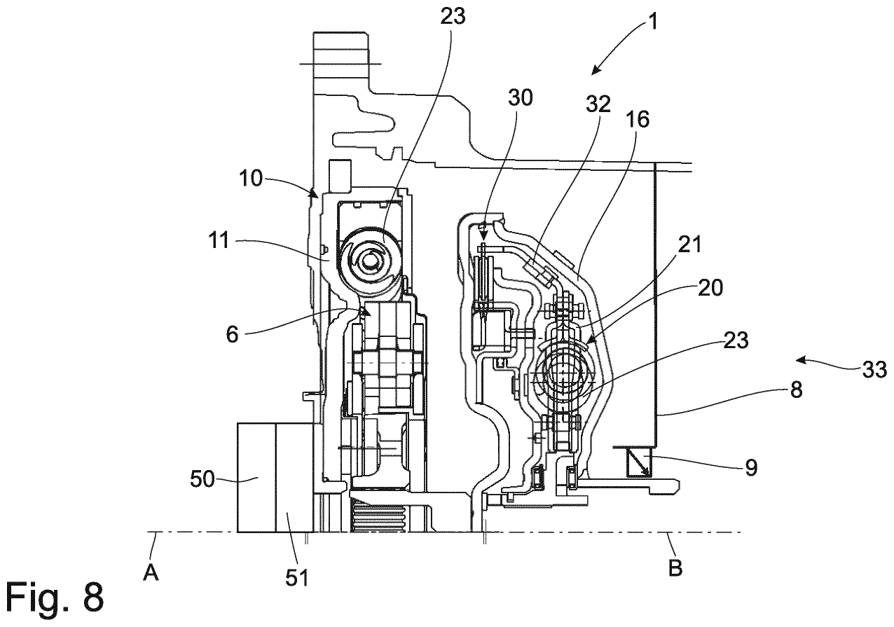

FIG. 8 shows a torsional vibration damping arrangement 1 as described in FIG. 7, but in which the slip arrangement 30 is arranged farther radially outside so that the second spring set 20 can be arranged farther radially inside in a compact manner and the mass damper arrangement 6 is arranged radially inside of the helical compression springs 23 of the first spring set 10, and the separating wall 4 is also omitted here. Axial installation space can be saved in this way. Since the slip arrangement 30 with the second spring set 20 is enclosed in an oil-tight manner by a housing element 16, the first spring set 10 constructed in this instance as a dual mass flywheel can be received with the mass damper arrangement 6 and the slip arrangement 30 with the second spring set 20 in a common space which is dry or contains oil mist or is partially filled with oil. The combination of the first spring set 10, which is constructed as a dual mass flywheel, with internal mass damper unit 6, both in the dry space 24, or with a wet slip arrangement 30 in the closed housing 16 rotating along with the latter offers a very good decoupling of rotational irregularities in a construction with only a small axial extension. This narrow construction is accordingly suitable particularly in applications where installation space is critical such as in transmissions for front transversely mounted engines. Due to the modular construction, it is possible to use some components also for other powertrain variants.

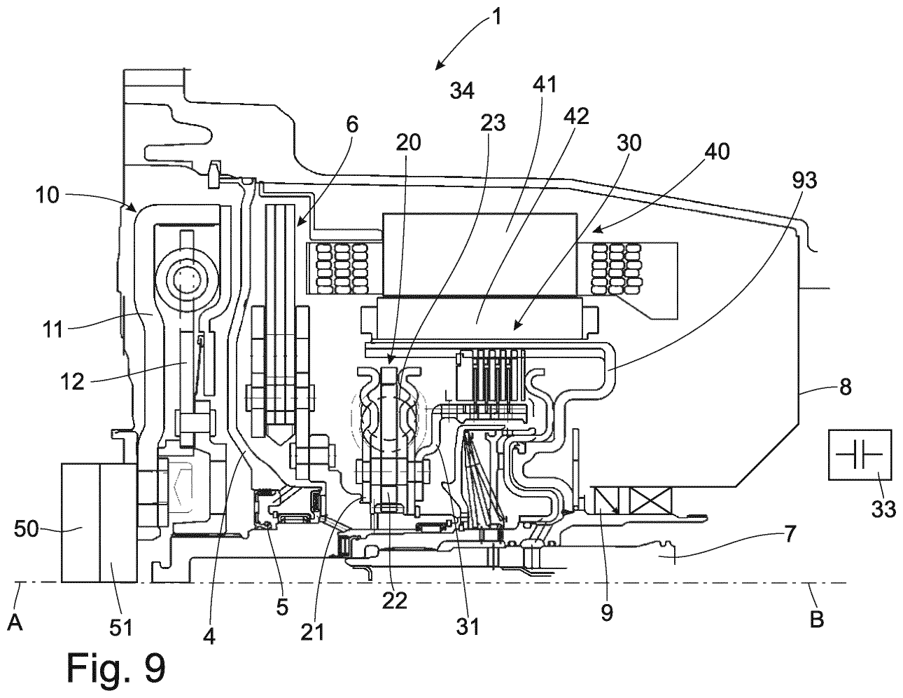

FIG. 9 shows a torsional vibration damping arrangement 1 as described in FIGS. 1 and 2 but in which an electric drive unit 40 is additionally arranged on the output part 32 of the slip arrangement 30, a stator 42 of the electric drive unit 40 is connected to the housing element 34 so as to be fixed with respect to rotation relative to it, and the rotor is connected to an outer disk carrier 93 of the slip arrangement 30 so as to be fixed with respect to rotation relative to it.

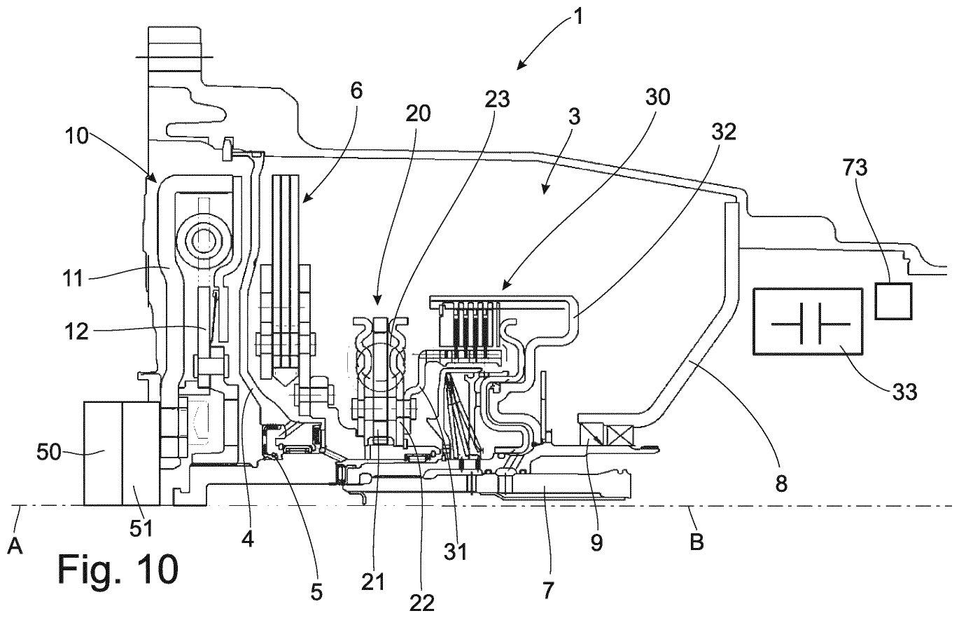

FIG. 10 shows a torsional vibration damping arrangement 1 as described in FIGS. 1 and 2. In this instance, however, the starting function is taken over by one or more clutches or brakes integrated in the transmission, advantageously in automatic planet gear transmissions. But since the starting functionality is realized through a clutch or brake integrated in the transmission, the slip arrangement 30 can in some cases be constructed smaller and lighter so as to be optimized for the slip function, which again results in a reduced mass moment of inertia.

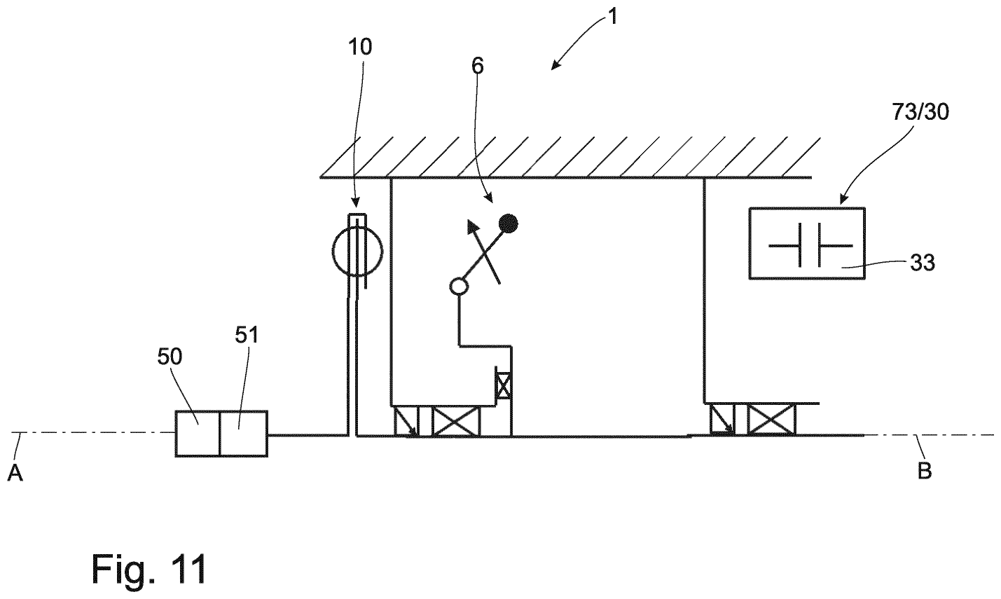

FIG. 11 shows a torsional vibration damping arrangement 1 with a first spring set 10 and a downstream mass damper unit 6. The starting function and the slip function are taken over by one or more clutches or brakes (73; 30), also as internal starting element, integrated in the transmission.

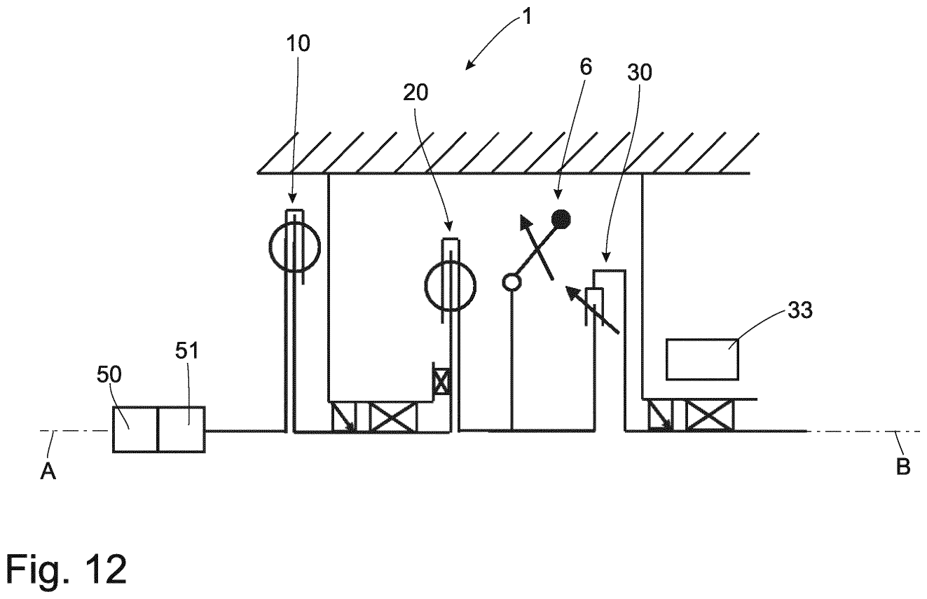

FIG. 12 shows a torsional vibration damping arrangement 1 with a first spring set 10, a downstream second spring set 20 and a downstream mass damper unit 6. The slip arrangement 30 is arranged downstream of these three elements and upstream of the gear unit 33. This construction offers an excellent decoupling because the arrangement of mass damper unit 6 downstream of first spring set 10 and second spring set 20 in connection with the slip arrangement 30 is the most efficient topology.

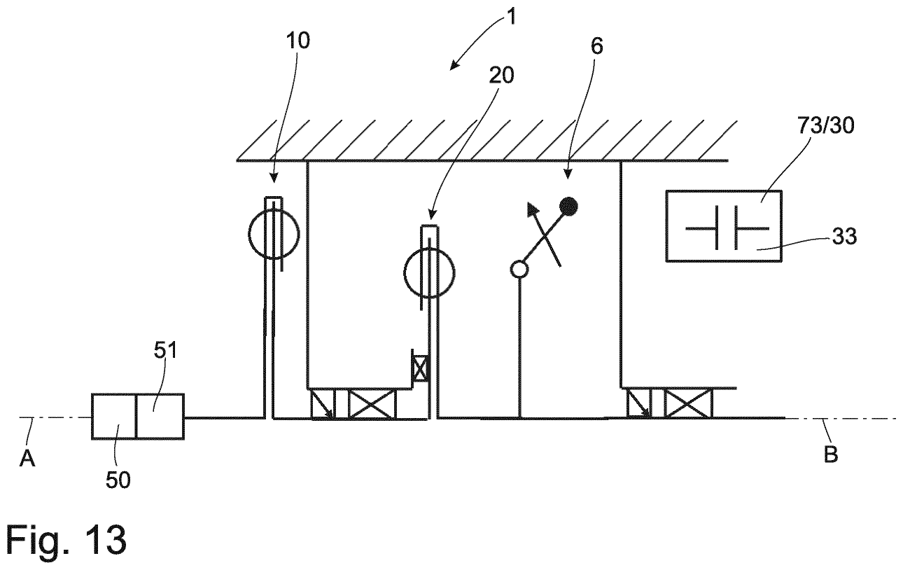

FIG. 13 shows a torsional vibration damping arrangement 1 with a first spring set 10, a downstream spring set 20 and a downstream mass damper unit 6. The starting function and slip function are taken over in the gear unit 33 by one or more clutches or brakes 73; 30, also known as internal starting element, integrated in the gear unit 33. Since both the starting function and the slip function are taken over by one or more clutches or brakes, also known as internal starting element, integrated in the transmission, there is a reduced mass moment of inertia and more space for more efficient spring sets 10, 20 and/or for the mass damper unit 6 compared with FIG. 1.

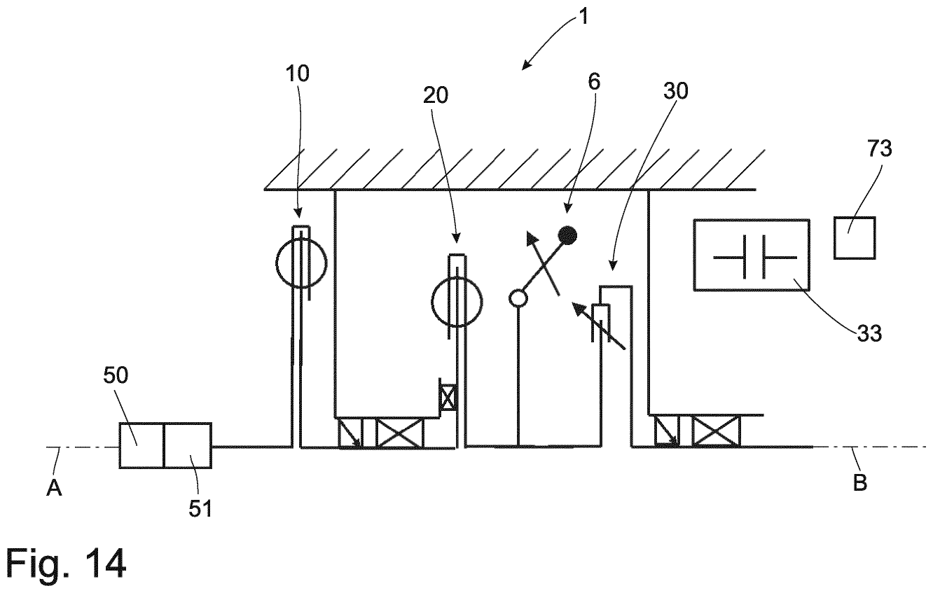

FIG. 14 shows a torque transmission arrangement 1 as described in FIG. 12. However, the starting function is taken over by one or more clutches or brakes 73; 30, which are positioned and integrated in the gear unit 33. But since the starting functionality is realized through a clutch or brake integrated in the transmission, the slip arrangement 30 can be optimized for the slip function or also constructed to be smaller and lighter, which again results in a reduced mass moment of inertia. Further, the latter need not be able to disconnect completely and in some cases need not be optimized for drag torques.

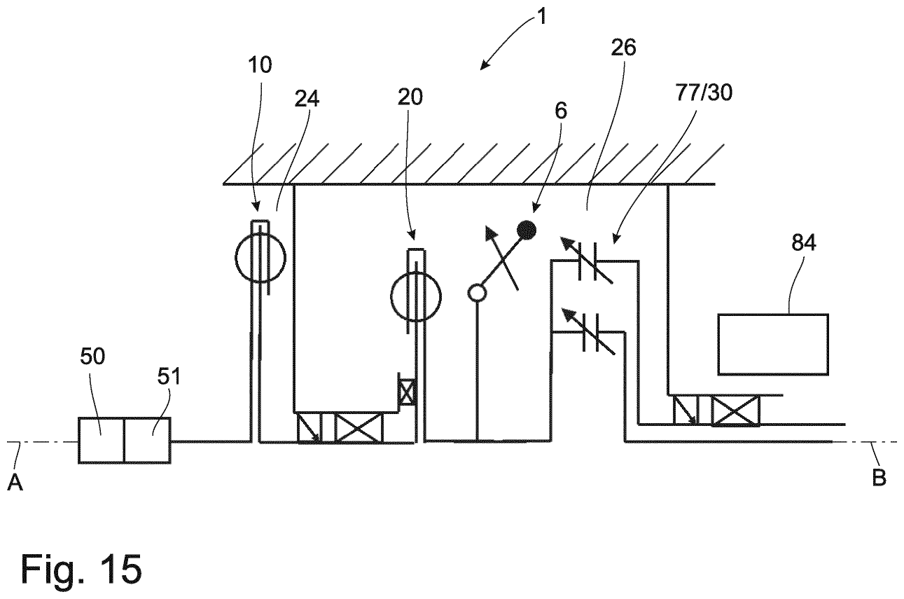

FIG. 15 shows a torque transmission arrangement 1 with a first spring set 10, a downstream second spring set 20, and a downstream mass damper unit 6. The slip arrangement 30 is a dual clutch 77 in this case. The gear unit 33 is constructed in the present instance as a dual clutch transmission 84. As is shown here, the first spring set is positioned in the dry space 24 and the second spring set 20, mass damper unit 6 and dual clutch 77 are placed in the moist space 26. It is also conceivable to provide the dual clutch 77 with a closed housing so that the second spring set 20 and the mass damper unit 6 can also be operated in the dry space 24. Instead of a slip clutch, a dual clutch is installed in this case open or closed (not shown) and transmits the torque as is customary via two coaxial shafts into the dual clutch transmission in which the two shafts are not simultaneously in operative engagement depending on the gear step. It is likewise conceivable to accommodate the arrangement in its entirety in the dry space and, for this purpose, to realize a closed dual clutch with oil filling. This variant functions in the same way as that shown in FIG. 12 but with dual clutch functionality. At least one of the two clutches can actively slip.

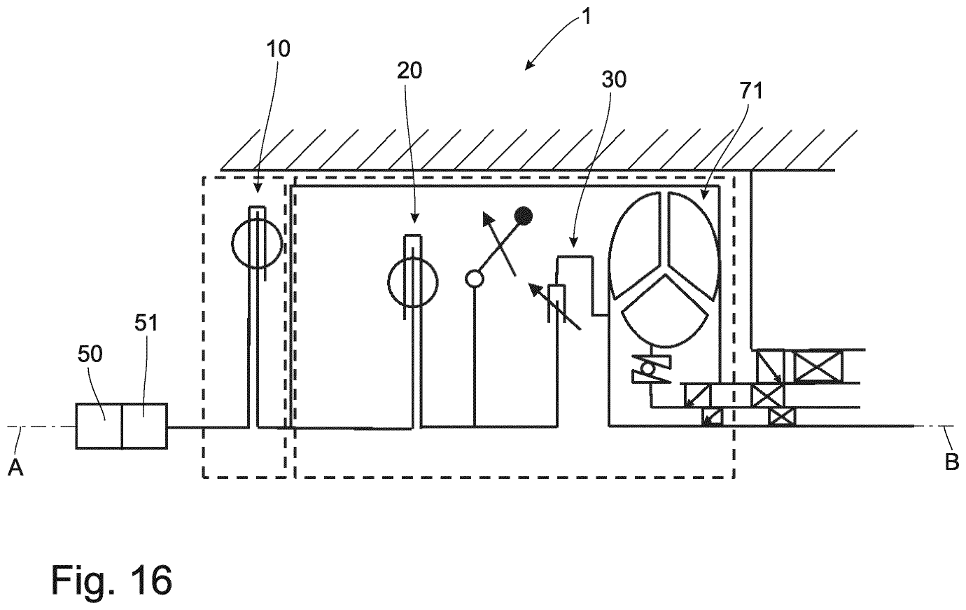

FIG. 16 shows a torque transmission arrangement 1 as already described in FIG. 12. In this case, however, a hydromechanical torque converter 71 is provided downstream of the slip arrangement 30 so that the torque transmission can be utilized when starting.

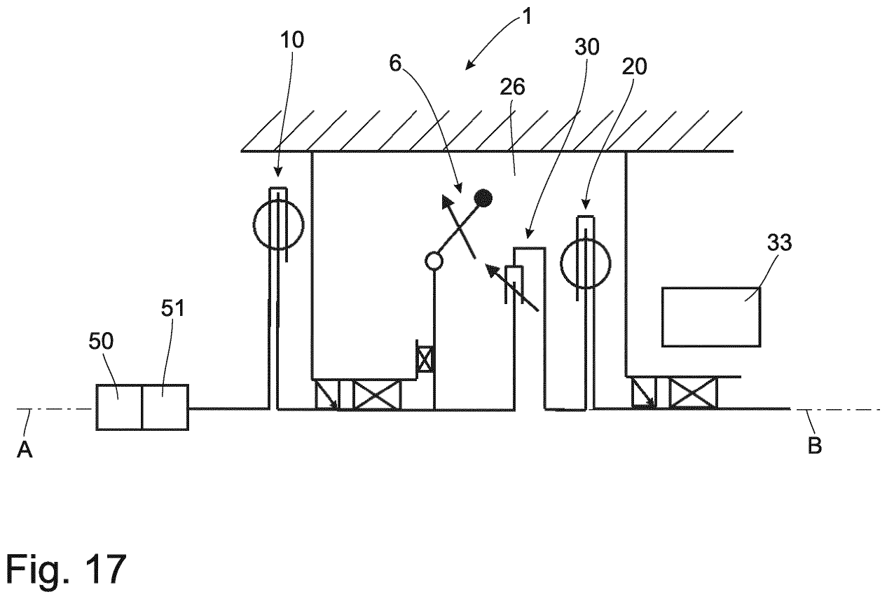

FIG. 17 shows a torque transmission arrangement 1 as already described in FIG. 5. In this case, however, the second spring set 20 is provided downstream of the slip arrangement 30 in the moist space 26.

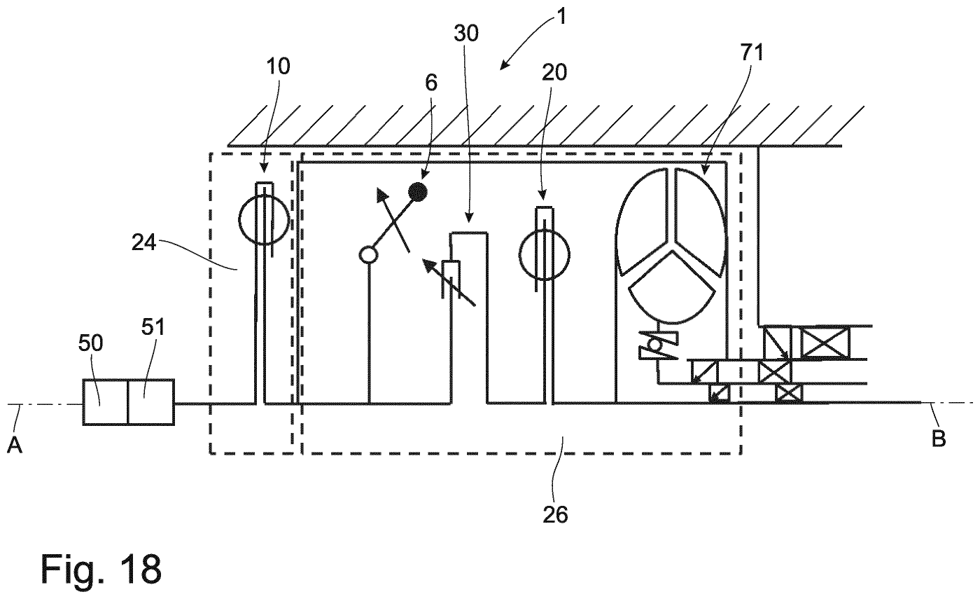

FIG. 18 shows a torque transmission arrangement 1 as already described in FIG. 17. However, a hydromechanical torque converter 71 is provided downstream of the second spring set 20. In this case also, the first spring set 10 is located in the dry space 24, and the mass damper unit 6 with the slip arrangement 30, the second spring set 20 and the hydromechanical torque converter 71 are located in the moist space 26 so that the torque transmission can be utilized during starting.

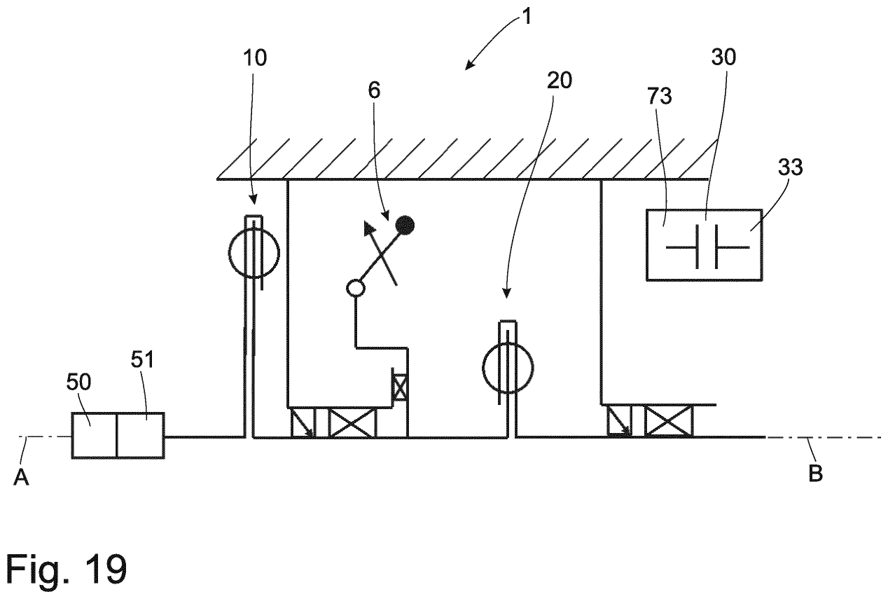

FIG. 19 shows a torque transmission arrangement 1 as already described in FIGS. 1 and 2, but without the slip arrangement 30 located in the moist space 26. The slip function as well as the starting function are taken over by one or more clutches or brakes 73; 30 integrated in the transmission. Compared with FIG. 1, there is a reduced mass moment of inertia and more space for more efficient spring sets 10, 20 and/or for the mass damper unit 6.

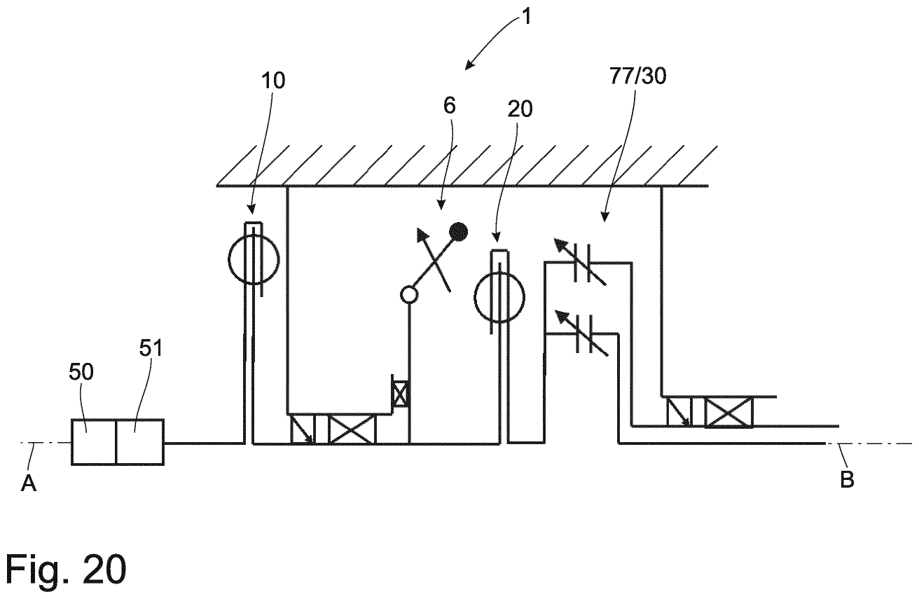

FIG. 20 shows a torque transmission arrangement 1 as already described in FIG. 15. However, the mass damper unit 6 in this case is positioned between the first spring set 10 and the second spring set 20. The slip and the starting function are taken over in this case by the dual clutch 77, which also operates as slip arrangement 30 and transmits the torque as is customary via two coaxial shafts into the dual clutch transmission in which the two shafts are not simultaneously in operative engagement depending on the gear step. It is likewise conceivable to accommodate the arrangement in its entirety in the dry space and, for this purpose, to realize a closed dual clutch with oil filling. At least one of the two clutches can actively slip.

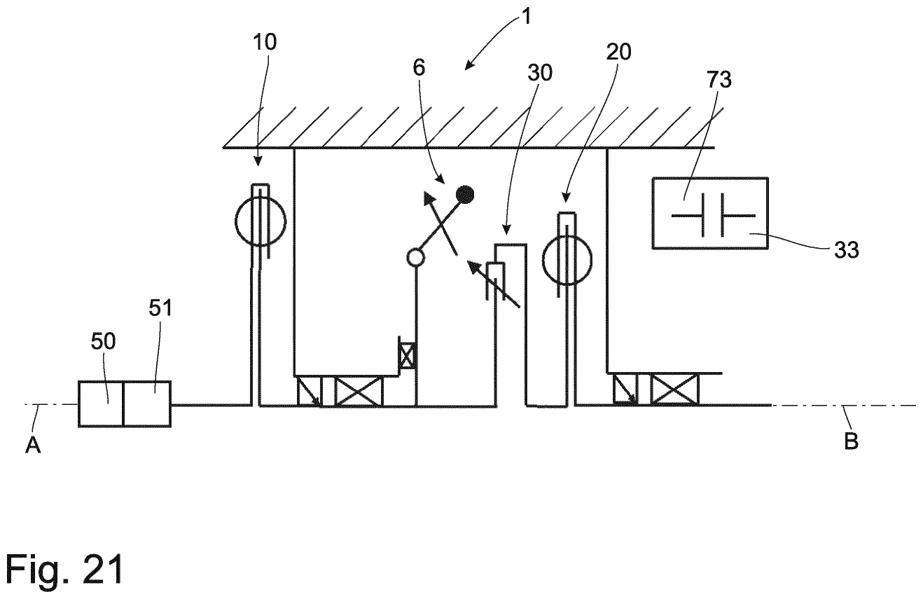

FIG. 21 shows a torque transmission arrangement 1 as already described in FIG. 17. However, the starting function is taken over by a starting element 73, which is located in the gear unit 33. The starting element 73 can be one or more integrated clutches or brakes in the gear unit 33. Accordingly, the slip arrangement 30 can be optimized for the slip function or, in some cases, constructed to be smaller and lighter, which again results in a reduced mass moment of inertia. Further, the latter need not be able to disconnect completely and in some cases need not be optimized for drag torques.

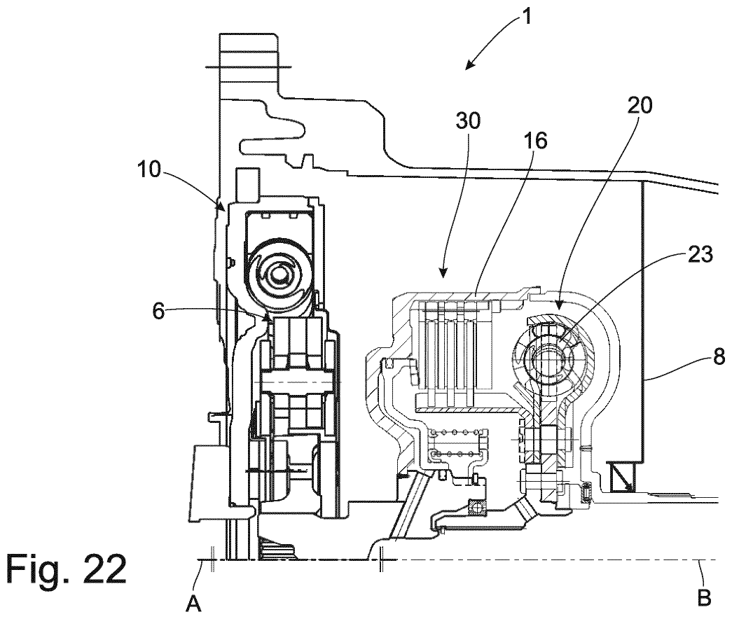

FIG. 22 shows a torque transmission arrangement 1 as already described in FIG. 8. In this case, however, the slip arrangement 30 is formed as a hydrodynamic multiple plate clutch. The hydrodynamic multiple plate clutch is surrounded by a housing element 16 and can therefore be operated in the dry space like the first spring set with mass damper unit 6. The second spring set 20 is provided inside of the housing element 16. Housing element 16 encloses the hydrodynamic multiple plate clutch in the second spring set in an oil-tight manner. As a result of the modular construction, it is possible to also use some components for other powertrain variants.

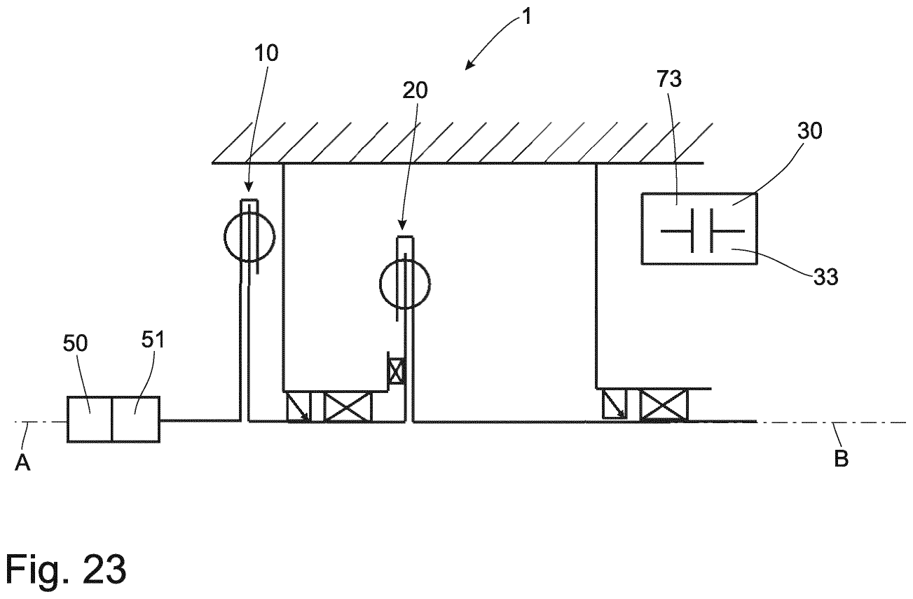

FIG. 23 shows a torque transmission arrangement 1 with a first spring set 10, which is positioned in the dry space 24. A second spring set 20 is positioned subsequently in a moist space 26. The starting function and slip function are taken over in this case in the gear unit 23 by a starting element 73 and a slip arrangement 30. The starting function and slip function can be carried out by one or more clutches or brakes integrated in transmissions. The omission of the mass damper unit 6 and separate slip arrangement 30 allows a very small axial construction. In addition, without the mass damper unit 6 and the positive effects of the slipping internal starting element, freedom is gained in the configuration of the two remaining spring sets 10, 20. Accordingly, as a result of the slip in the internal starting element, a better decoupling can be achieved than with two conventional spring sets 10, 20 connected in tandem with rigid through-drive.

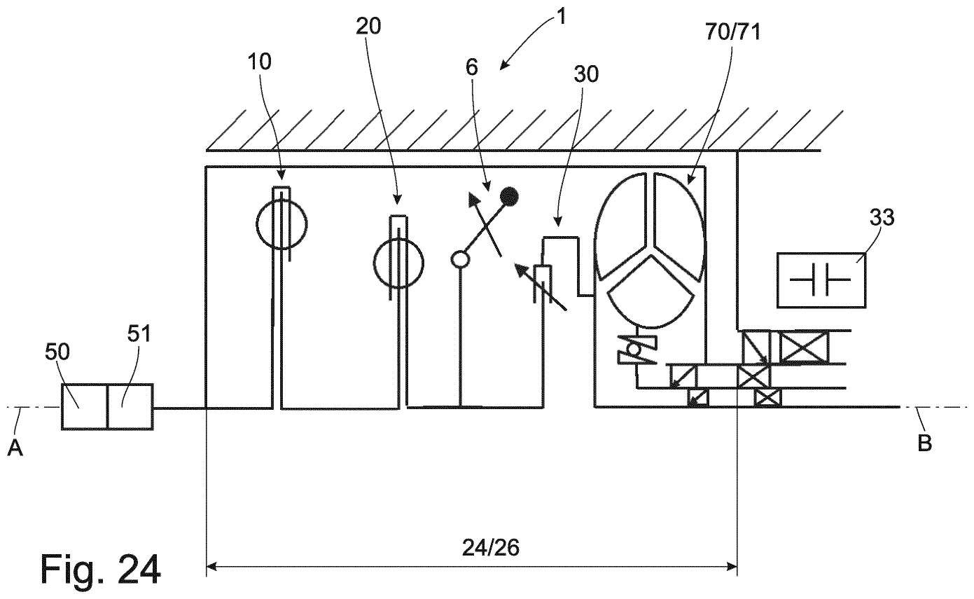

FIG. 24 shows a torque transmission arrangement 1 as already described in FIG. 16. However, in this case the first spring set, subsequently the second spring set, subsequently mass damper unit 6, subsequently slip arrangement 30 followed by converter unit 70 are provided in a spatial area, preferably a dry space or moist space. However, since the decoupling of rotational irregularities in its entirety is arranged in the wet space and the converter housing is now arranged on the primary side and no longer between the two spring sets 10, 20 as intermediate mass, this is advantageous for decoupling.

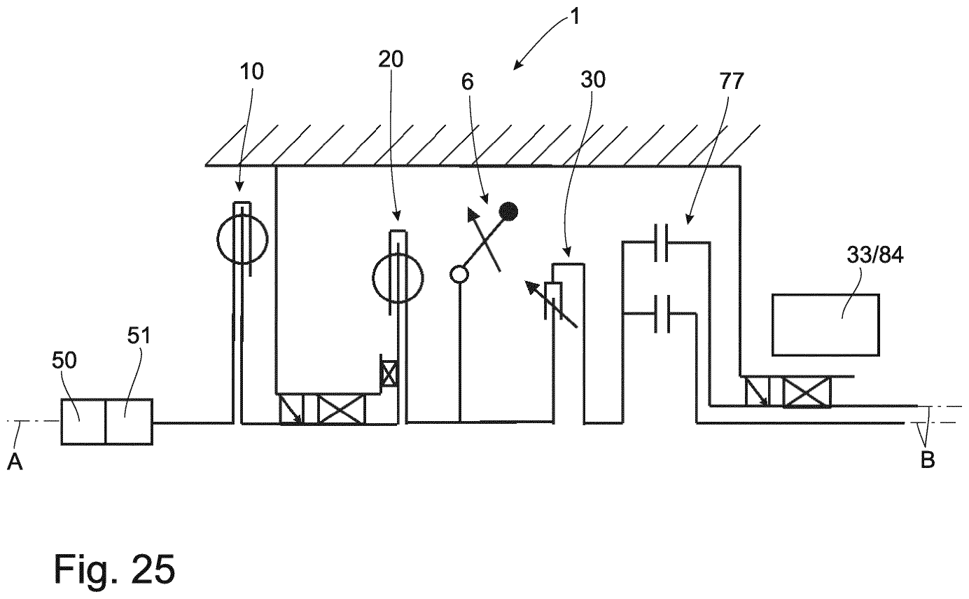

FIG. 25 shows a torque transmission arrangement 1 as already described in FIG. 15. However, in this case a slip arrangement 30 is provided in front of the dual clutch 77. Accordingly, the slip function is carried out solely by the slip arrangement 30 and the starting function is carried out solely by the dual clutch 77.

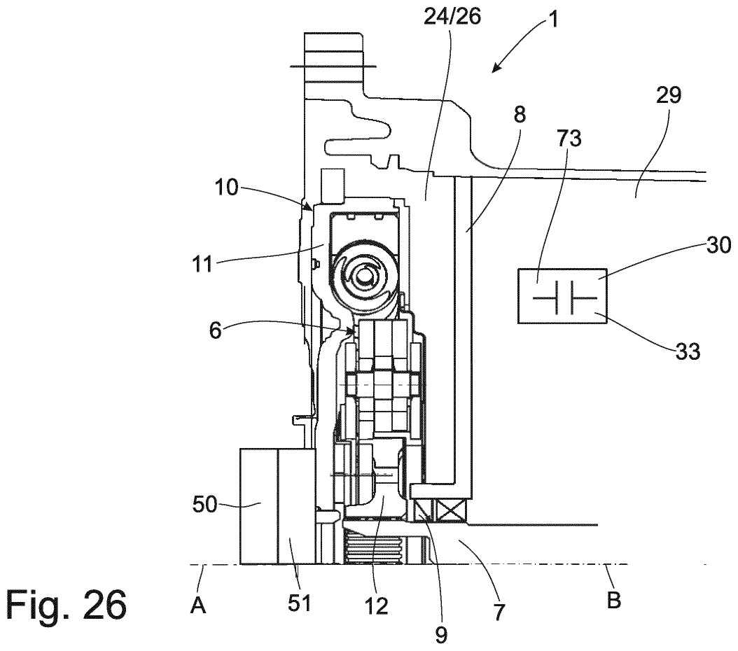

FIG. 26 shows a torque transmission arrangement 1 as already described in FIG. 8. In this case, however, the second spring set 20 is omitted. The starting function and slip function are provided in the gear unit 33 in the present instance. The starting function can be taken over by a starting element 73, for example, one or more clutches or brakes in the gear unit 33. The slip function is taken over by a slip arrangement which is likewise located in the gear unit 33. This slip function can also be taken over by a starting element, for example, a brake or a clutch. The first spring set 10 and the mass damper unit 6 are located in a dry space 24 or a moist space 26, whereas the starting element 73 and the slip arrangement 30 are located in the wet space 29.

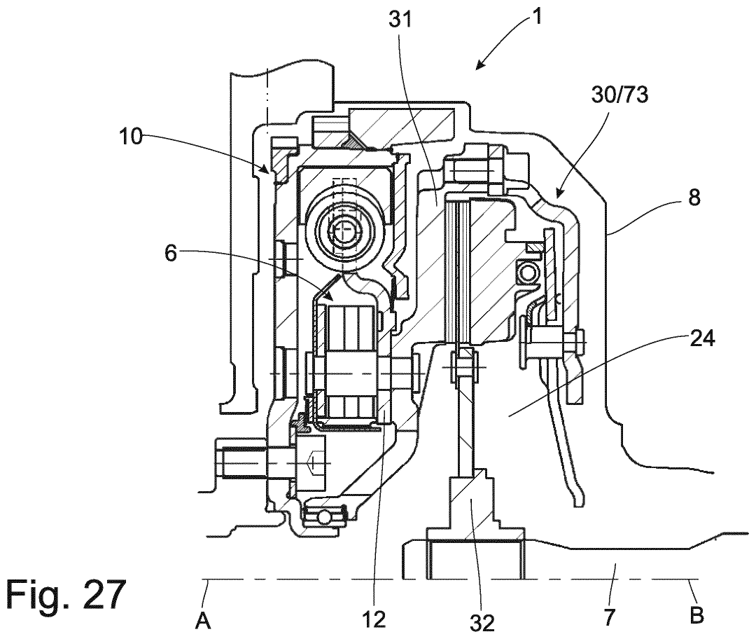

FIG. 27 shows a torque transmission arrangement 1 as already described in FIG. 26. However, the starting function and the slip function are taken over by a dry single-disk clutch. The first spring set 10, the mass damper unit 6 and slip arrangement 30 which is also used as starting element 73 are preferably located in a dry space 24.

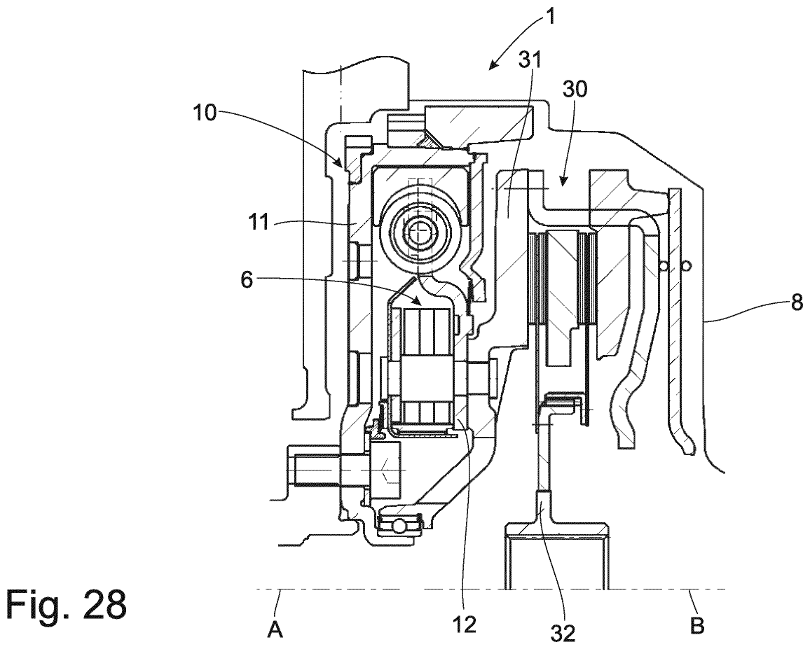

FIG. 28 shows a torque transmission arrangement 1 as already described in FIG. 27. However, the slip arrangement 30 and starting element 73 are formed by a dual-disk dry clutch.

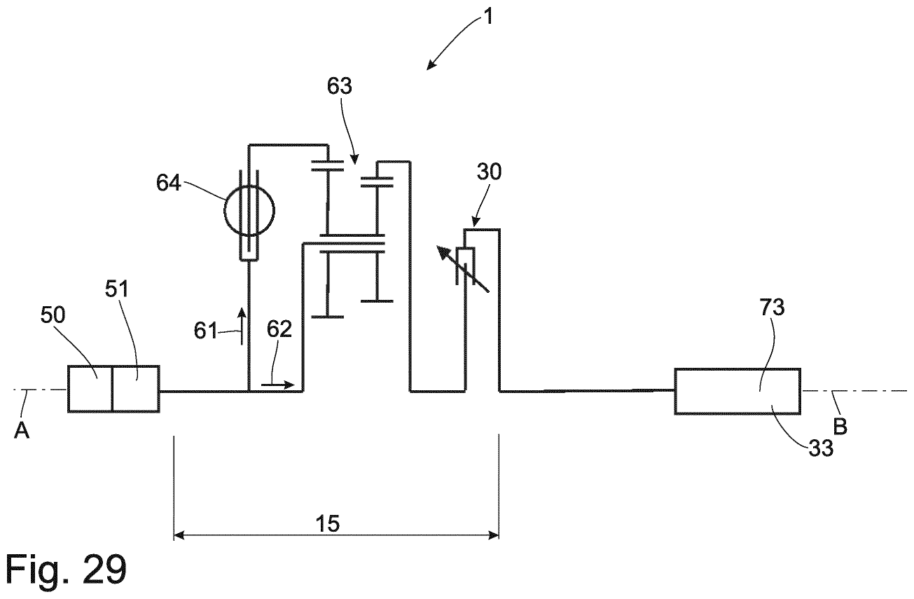

FIG. 29 shows a torque transmission arrangement 1 with a slip arrangement 30 between a drive unit 50 and a gear unit 33. Upstream of the slip arrangement 30 is a torsional vibration damping unit 15, specifically with a first torque transmission path 61 and a second torque transmission path 62, both of which proceed from the drive unit 50. A phase shifting arrangement 64 is located in the first torque transmission path 61. The first torque transmission path 61 and the second torque transmission path 62 intersect at a clutch arrangement 63 which is formed in this instance as a planet gear transmission. The output area of the clutch arrangement 63 is formed by a ring gear which is connected to the input part of the slip arrangement 30 so as to be fixed with respect to rotation relative to it. The downstream slip arrangement 30 can be provided in the various configurations mentioned above, for example, a multiple plate clutch, a dual clutch, a converter lockup clutch or as a starting element that fits in the gear unit 33. The downstream slip arrangement 30 allows an even better decoupling of rotational irregularities particularly in the low speed range and for cylinder deactivation. Very different variants of the coupling arrangement 63 and clutch are conceivable. The slip arrangement 30 can be constructed in various ways as already mentioned, for example, a multiple plate clutch, dual clutch, converter lockup clutch or an internal starting element in the transmission.

The coupling gear can also be constructed in very different variants, for example, a double ring gear transmission, double sun gear transmission, sun gear and ring gear, linkage gear, and so on.

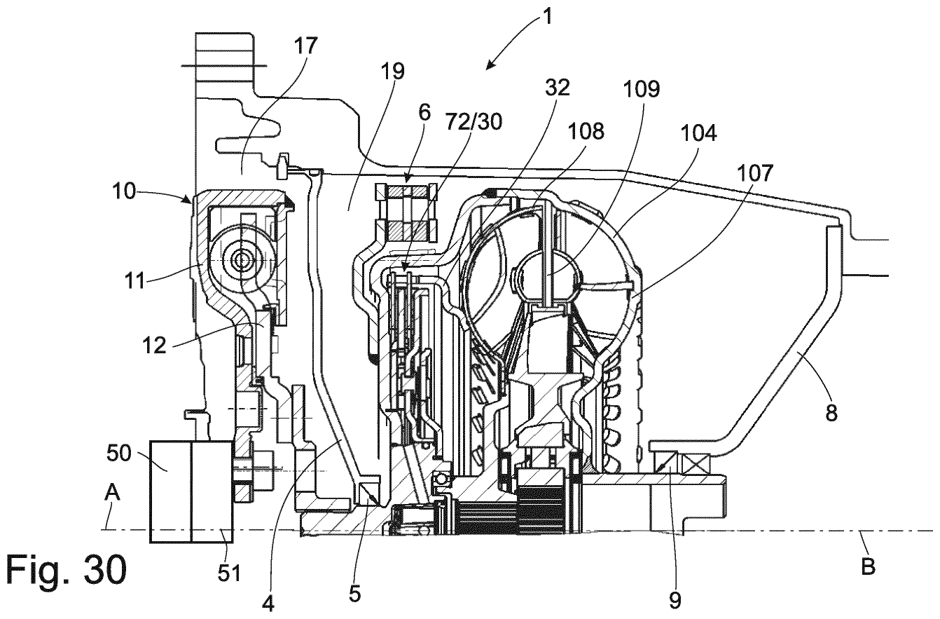

FIG. 30 shows a torque transmission arrangement 1 in which the input part 11 of the first spring set 10 is connected to the crankshaft 51 so as to be fixed with respect to rotation relative to it. The first spring set 10 is designed as a dual mass flywheel with spring plate/sliding shoes. Alternatively, this can also be formed with arc springs. It can be filled with a lubricant (oil or grease) and is located in the dry first space 24, i.e., this space is free of lubricant. The output part 12 of the first spring set 10 is connected to the co-rotating converter housing 104 so as to be fixed with respect to rotation relative to it. A mass damper unit 6 which is located radially inside of the first spring set 10 is connected to the converter housing 104. With corresponding installation space conditions, the latter can also be arranged radially inside of the first spring set 10 in order to save axial installation space. The mass damper unit 6 is a speed-variable mass damper but can also be formed as a fixed-frequency mass damper. It can also be configured as a speed-variable mass damper to two engine orders. The converter housing 104 is part of the hydrodynamics via the impeller 107 and drives the turbine 108. The stator 109 is supported via a freewheel. The hydrodynamic arrangement can be bridged via a slippable converter lockup clutch 72 which also operates as slip arrangement 30. The output part 32 of the converter lockup clutch 72 is connected to the turbine 108 so as to be fixed with respect to rotation relative to it, this turbine 108 being in turn connected to the transmission input shaft 7 so as to be fixed with respect to rotation relative to it.

The first spatial area 17 is separated from the second space 19 by a separating wall 4 and a seal 5. The first space 17 is dry, i.e., free of lubricant, whereas there is a lubricant in the second space 19. Oil in the form of an oil mist, a droplet lubrication or an oil bath is preferably provided for this purpose. Alternatively, it is also possible to use a lubricating grease or a semifluid grease. A droplet lubrication could also be realized, for example, by a valve correspondingly placed in the converter housing 104 and which directly faces the damper bolt. However, the first separating wall 4 can also be dispensed with so that a large, preferably dry first space 17 results. A separating wall 8 is provided with a seal 9 for oil-tight sealing of the first space 17 and second space 19 from the wet space 29 of the transmission.

Alternatively, one or more further spring sets can be arranged downstream of the first spring set 10 and can be situated between first spring set 10 and mass damper unit 6 or downstream of mass damper unit 6.

The gear unit 33 can be constructed as a conventional stepped automatic transmission, a manual transmission, an automatic transmission, a dual clutch transmission or a shiftless transmission. Further, it can also contain electric drive components such as mild hybrid, full hybrid or plug-in hybrid. Moreover, additional or standalone electric drive components, for example, a belt-driven starter generator, can also be realized upstream or downstream of the transmission, between engine and torque transmission unit, upstream of the engine or in the torque transmission unit. The torque multiplication of the torque converter 70 can be used during the starting process. Owing to the modular construction, it is possible to also use some components for other powertrain variants.

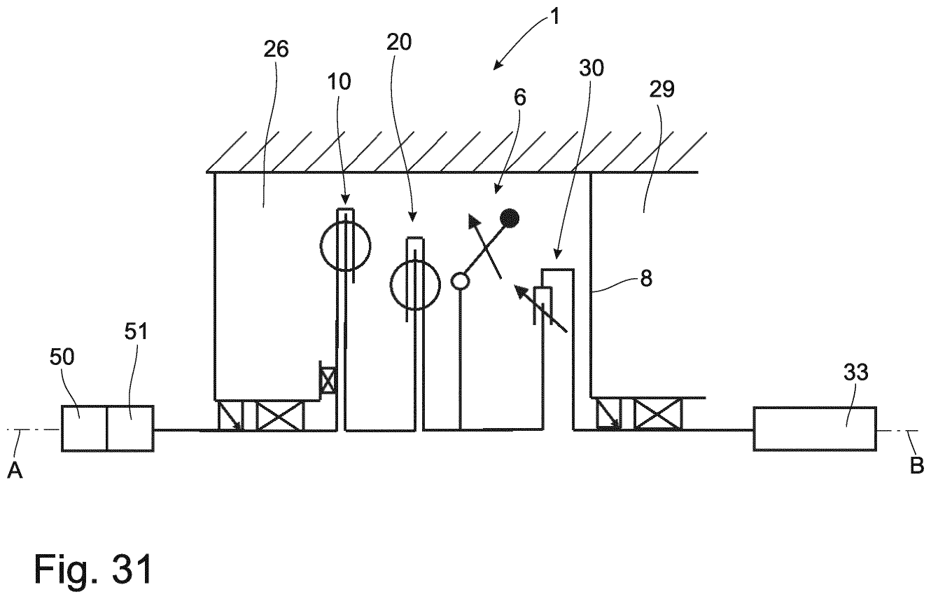

FIG. 31 shows a variant as described in FIG. 12, but entirely in the wet space. If allowed by the boundary conditions, it is also possible to remove the separating wall between wet space and transmission and, accordingly, to integrate the torsional vibration damping unit directly into the transmission.

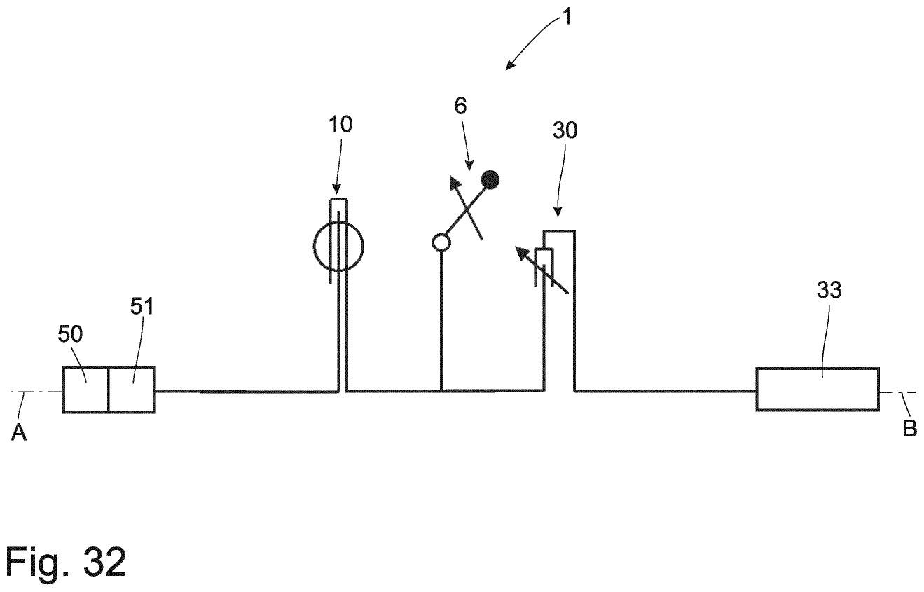

FIG. 32 shows a torque transmission arrangement 1 with a preferred topology, namely, a first spring set, optionally directly followed by further spring sets, a mass damper unit 6, a slip arrangement 30 and the downstream gear unit 33. In FIG. 32, the starting function would likewise be taken over in this case by the slip arrangement 30.

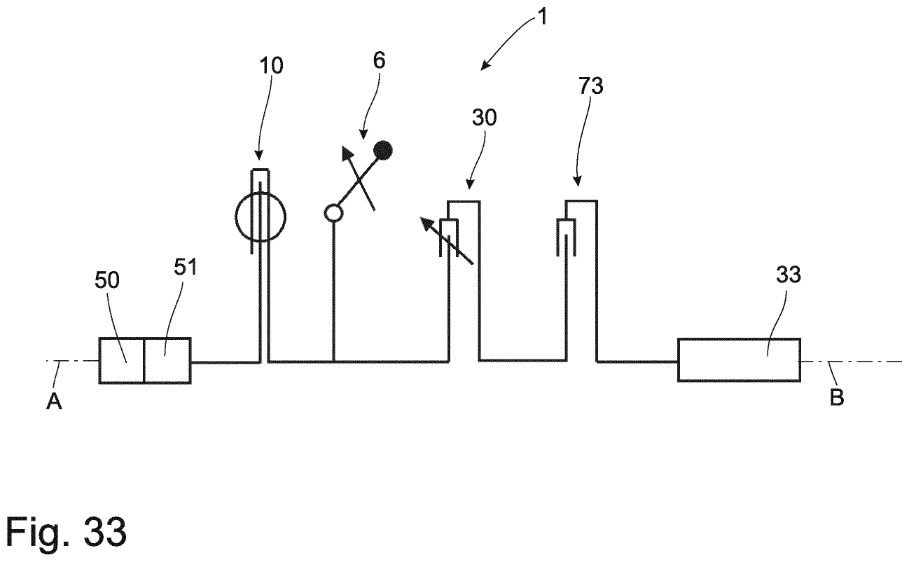

FIG. 33 shows a torque transmission arrangement 1 as already described in FIG. 32, but in this case, besides the slip arrangement 30, there is an additional starting element 73 which takes over the actual starting process.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-21. (canceled)

22. A torque transmission arrangement for a powertrain of a motor vehicle, comprising:
an input area rotatable around a rotational axis;
an output area rotatable around a rotational axis;
a torque path from the input area to the output area;
a torsional vibration damping unit is positioned along the torque path between the input area and the output area,
a gear unit is positioned after the torsional vibration damping unit along the torque path between the input area and the output area; and
at least one of a first slip arrangement and/or a second slip arrangement for generating a speed slip are/is provided in the torque path between the input area and the output area and configured to damp vibration.

23. The torque transmission arrangement according to claim 22, wherein the at least one of the first slip arrangement and/or the second slip arrangement provides a speed slip that is one of fixed and adjustable at an operating point of the torque transmission arrangement.

24. The torque transmission arrangement according to claim 22, wherein the torsional vibration damping unit comprises along the torque path at least a first spatial area that is one of a dry space and a moist space.

25. The torque transmission arrangement according to claim 24, wherein the torsional vibration damping unit comprises along the torque path a second spatial area that is one of a dry space and as a moist space.

26. The torque transmission arrangement according to claim 25, wherein the gear unit comprises a third spatial area formed as a wet space.

27. The torque transmission arrangement according to claim 26, wherein at least one of: a first spring set, a mass damper unit, a second spring set, the first slip arrangement, an electric drive unit, and a first starting element is provided in the torsional vibration damping unit in torque path.

28. The torque transmission arrangement according to claim 27, wherein one of a converter unit or a dual clutch is provided in the torsional vibration damping unit in torque path in the first spatial area and/or in the second spatial area.

29. The torque transmission arrangement according to claim 26, wherein a second starting element and/or the second slip arrangement is arranged in the third spatial area and in the torque path.

30. The torque transmission arrangement according to claim 28, wherein the converter unit comprises a torque converter with a converter lockup clutch.

31. The torque transmission arrangement according to claim 27, wherein the mass damper unit is one of: a speed-variable mass damper unit, a fixed-frequency mass damper unit, or a mass damper unit for two or more engine orders.

32. The torque transmission arrangement according to claim 22, wherein the gear unit comprises:
a transmission arrangement constructed as one of an automatic planet gear transmission, a manual or automatic shift transmission, a dual clutch transmission, or a shiftless transmission.

33. The torque transmission arrangement according to claim 22, wherein the first slip arrangement is constructed as one of a dry single disk clutch, a dry multiple disk clutch, a wet multiple plate clutch, a planetary transmission with a brake, a magnetorheological clutch, an electrorheological clutch, a magnetic clutch, or a magnetic particle clutch.

34. The torque transmission arrangement according to claim 22, wherein the one of the first slip arrangement and/or the second slip arrangement forms a starting clutch.

35. The torque transmission arrangement according to claim 25, wherein the first spatial area is separated from the second spatial area by a separate separating element.

36. The torque transmission arrangement according to claim 35, wherein the separating element comprises a radially outwardly circumferentially extending seal.

37. The torque transmission arrangement according to claim 24, wherein torsional vibration damping unit comprises a third spatial area configured as a wet space, wherein the first spatial area is separated from the third spatial area a separating element constructed as one of a separate separating element, formed integrally with a housing element of the torsional vibration damping unit, or integral with a housing element of the gear unit.

38. The torque transmission arrangement according to claim 26, wherein the second spatial area is separated from the third spatial area by a separating element which is one of formed as a separate separating element, formed integral with a housing element of the torsional vibration damping unit, or integral with a housing element of the gear unit.

39. The torque transmission arrangement according to claim 38, wherein the housing element of the torsional vibration damping unit and the housing element of the gear unit are formed integrally.

40. The torque transmission arrangement according to claim 27, wherein at least one of the first spring set and the second spring set is formed in one or more rows.

41. The torque transmission arrangement according to claim 22, wherein the rotational axis runs is one of coaxial to rotational axis axially offset to rotational axis.

42. The torque vibration damping arrangement with a torque transmission arrangement according to claim 22, further comprising, between the input area and the output area:
a first torque transmission path;
a second torque transmission path parallel to the first torque transmission path;
a coupling arrangement for superposing respective torques conducted via the first and second torque transmission paths are provided;
a first phase shifter arrangement is provided in the first torque transmission path configured to generate a phase shift of rotational irregularities conducted via the first torque transmission path relative to rotational irregularities conducted via the second torque transmission path,
wherein the first slip arrangement is provided after the coupling arrangement in the torque path.
